(19) United States
(12) Patent Application Publication
(10) Pub. No.: US 2004/0116619 A1
(43) Pub. Date: Jun. 17, 2004

(54) Polyester resins with improved properties

(76) Inventors: Graeme Moad, Victoria (AU); Andrew Mason Groth, Victoria (AU); Michael Shane O'Shea, Victoria (AU); Ramon Dean Tozer, Victoria (AU)

Correspondence Address: SEED INTELLECTUAL PROPERTY LAW GROUP PLLC, 701 FIFTH AVE, SUITE 6300, SEATTLE, WA, 98104-7092, US

(21) Appl. No.: 10/380,303

(22) PCT Filed: Sep. 12, 2001
(86) PCT No.: PCT/AU01/01148

(30) Foreign Application Priority Data
Sep. 12, 2000 (AU) PR0050/00

(51) Int. Cl. C08G 63/02

(52) U.S. Cl. 525/418

(57) ABSTRACT

A polyester composition which is obtainable by combining a precursor polyester comprising at least one transesterification resistant segment with another polyester and/or monomer, wherein the transesterification resistance of the segment is attributable to an alcohol or derivative thereof from which the precursor polyester is derived.

The present invention relates to a polyester composition and to a process for synthesising such a polyester composition based on the use of a precursor polyester comprising at least one transesterification resistant segment. The invention also relates to practical applications of block copolyesters.

Both the physical and chemical properties of a polyester are believed to be related to the arrangement of the repeat units within the polymer, and it has been observed that the properties of a block copolymer are different from those exhibited by a random copolymer equivalent (Textbook of Polymer Science, F. W. Billmeyer, chapter 7, John Wiley & Sons, Inc. 1971). The advantages of block copolymers are well known in that one may combine the desirable properties of two polymers and obtain improved performance relative to a random or statistical copolymer composed of the same monomer units. These properties may be optimised by control of the block length. Conventional techniques for preparing block copolyesters generally require the use of relatively mild processing conditions which must be strictly adhered to in order to avoid transesterification which results in undesired ester interchange reactions, thereby preserving the desired block structure.

As a practical illustration, it is known that polyesters based on certain diols or diacids, for example, isophthalic acid (IPA) or 2,6-naphthalene-dicarboxylic acid (NDA) have substantially better barrier properties than polyesters based on polyethylene terephthalate (PET). However, random copolymers incorporating significant amounts of IPA or NDA often have markedly worse processing properties. For the case of IPA copolymers, this stems in part from the lower Tg and lower crystallinity of random copolymers containing large quantities (>10%) of isophthalate units. With a block architecture, it is possible to design a material which combines high barrier properties associated with the presence of IPA or NDA units with the processing behaviour and mechanical properties of PET. However, conventional block polyesters are subject to transesterification during melt processing or solid stating steps required to transform the polymer into a finished product (for example a beverage container). This causes some degradation of the block structure and consequent diminution of the barrier and processing properties.

The mechanism by which transesterification occurs is believed to be through one or more of three pathways, namely acidolysis, alcoholysis and direct ester exchange, although their relative importance is unclear. Regardless of the pathway, it is generally accepted that transesterification results in the formation of random copolyesters, through transitional block intermediates. From a manufacturer's point of view, it is difficult to stop the transition from a block intermediate to a random copolyester. Usually this will involve preparing the copolyester under strictly controlled conditions.

For instance, U.S. Pat. No. 5,695,710 discloses a melt extrusion process to produce poly(ethylene terephthalate)/poly(ethylene 2,6-naphthalene dicarboxylate) (PET/PEN) block copolyesters. The block character of the copolyester is controlled by strict processing parameters, such as temperature and residence time. U.S. Pat. No. 5,688,874 discloses a melt processing/solid-stating technique to prepare PET/PEN block copolymers. The patent describes a process of solid-stating an immiscible PET/PEN blend, and this blend is prepared in an extruder in such a way as to avoid significant melt transesterification. The second stage solid-stating process is then used to promote and control subsequent transesterification. This method is also extremely reliant on stringent process control and demands narrow operating windows. Furthermore, post manufacture melt processing, such as injection moulding, extrusion and the like, of the so-formed block copolyesters tends to result in subsequent transesterification and thus reduces the integrity of the block structure. This will adversely influence the properties of the final product formed from the copolyester.

Other patents, for example, U.S. Pat. No. 4,704,417, U.S. Pat. No. 5,541,244, and U.S. Pat. No. 5,646,208 describe the benefits to be obtained from polyester compositions which do not undergo transesterification and disclose how transesterification inhibitors may be used to reduce the extent of transesterification that occurs during melt processing. The processes described in these patents require the use of an added reagent (e.g. a phosphate ester) to reduce the rate of transesterification and thus stabilise the composition.

An alternate process of preparing polyester compositions, such as block copolyesters, has now been found based on the use of a precursor polyester which contributes transesterification resistance. The process may be widely applied without the need for stringent operating parameters or added reagents. Moreover, the process is simple and effective, and offers a convenient means for controlling the degree of transesterification.

Accordingly, the present invention provides a polyester composition which is obtainable by combining a precursor polyester comprising at least one transesterification resistant segment with another polyester and/or monomer, wherein the transesterification resistance of the segment is attributable to an alcohol or derivative thereof from which the precursor polyester is derived. These components may be combined in a polycondensation, melt processing or solid stating operation. Melt processing is particularly preferred, and may be followed by a subsequent solid stating step.

Advantageously, it has been found that by employing the precursor polyester as described in a given manufacturing process the integrity of the block structure of the resulting product can be maintained within much wider windows of processing parameters than previously possible. By “maintained” is meant that the original segment length(s) of the transesterification resistant segment(s) is/are within ±50%, for instance within ±20%, and preferably within ±10%, of their original value. The process relies on the ability of the precursor polyester to resist transesterification with other polyester(s) and/or monomers during the course of a process such as polycondensation, melt processing, solid-stating, or any combination thereof. Furthermore, polyester compositions made using the process of the invention will essentially maintain their block character during post-manufacture processing as a direct result of the transesterification resistance of the segments.

It will be understood by those skilled in the art that the terms “polyester” and “polyesters” include homo-and co-polymer(s) that possess repeat ester groups in the backbone of the polymer(s). These repeat ester groups may also be referred to as “polyester repeat units” and as used herein refers to the repeating units usually formed from a polyacid and polyol linked together by an ester linkage in a polyester chain. The acid may include two or more acid groups and the polyol may have two or more alcohol groups. Typically, diacids and diols are employed. The repeat unit may also be formed from an acid-alcohol unit.

The term “transesterification resistant” as used herein in relation to a polyester, block, segment or repeat unit of a polyester, refers to the ability of the polyester, block, segment or repeat unit of the polyester to resist cleavage by transesterification when subjected to processes such as melt processing, polycondensation or solid-stating, which processes would otherwise cause significant transesterification of a transesterifiable polyester, such as PET. The term “transesterification resistant” is not intended to imply that transesterification is prevented completely, but only that the susceptibility to transesterification is substantially less than exhibited by a transesterifiable polyester, or transesterifiable block, segment or repeat unit of a polyester.

The exact mechanism by which transesterification resistance is achieved is unclear, and a number of mechanisms may contribute. The transesterification resistance of the precursor polyester and thus of the block copolyester, may be due to steric hindrance introduced in proximity to the ester linkage by nature of the alcohol used to form the precursor polyester. Such steric hindrance results in the ester moiety being less capable of taking part in transesterification reactions. Transesterification resistance may also be due to formation of the precursor polyester using an alcohol which has substituents which through electronegativity reduce the ability of the resultant ester linkage to take part in transesterification reactions.

A further possible mechanism may involve steric hindrance in proximity to the hydroxyl group of the alcohol used in forming the precursor polyester such that free hydroxyl groups, for example at the end of a polymer molecule, are hindered from reacting with the ester linkage, thereby inhibiting inter-chain transesterification reactions.

It may also be the case that hydrophobicity in close proximity to an ester linkage may retard attack by polar nucleophilic hydroxyl groups, the hydrolysis resistance of neopentyl glycol based polyesters may be due to the this kind of mechanism.

While the exact mechanism by which transesterification resistance is achieved is not understood in all cases, it is a feature of this aspect of the present invention that the nature of the alcohol or derivative thereof from which the precursor polyester is derived contributes to the transesterification resistance observed. This said, the nature of the complimentary component used in forming the precursor polyester may also contribute to the overall transesterification resistance observed.

For the sake of completeness it is mentioned that polarisation factors and the concentration of the ester functionality may also contribute to transesterification resistance.

The term “precursor polyester” as used herein refers to a polyester which comprises at least one transesterification resistant segment and which may be combined with another polyester and/or monomer to produce a polyester composition according to the present invention. The precursor polyester may itself be a block copolyester in accordance with the present invention. The precursor polyester may be an oligomer or polymer consisting of transesterification resistant polyester repeat units, or may be an oligomer or polymer which comprises at least one segment of transesterification resistant polyester repeat units.

Herein the term “alcohol” is used to denote any compound which reacts via a free hydroxyl group to form an ester linkage in the precursor polyester. The compound may of course include other functional groups. The term also embraces short chain (C₁₋₆) alkyl ester derivatives of an alcohol.

Combination of the precursor polyester with another polyester and/or monomers yields different products depending upon such factors as the relative proportions of the individual components, the rate of incorporation of the precursor polyester and the extent to which the precursor polyester is transesterification resistant. Thus, the polyester composition formed may be a blend of the individual components employed. In a preferred embodiment, the individual components react to produce a block copolyester. It is of course possible that the polyester composition comprises a block copolyester reaction product in the form of a blend with one or more of the individual components. The term “polyester composition” is used herein to denote the range of products obtained when the individual components are combined and, possibly, reacted.

The precursor polyester unit may be derived from an alcohol or alcohol-acid which includes a moiety which imparts trans esterification resistance, with a complementary component, such as an acid or acid-alcohol, required to form an ester. The complementary component may also include a moiety which will impart transesterification resistance, but this is not essential.

A variety of alcohols and alcohols-acid that may be suitable for providing transesterification resistance to the precursor polyester are shown below. Typically, the alcohol is a diol. The following structures of formulae (I) to (VI) serve as examples, although it is understood that these examples are included merely for the purposes of understanding and are not intended to limit the scope of the present invention.

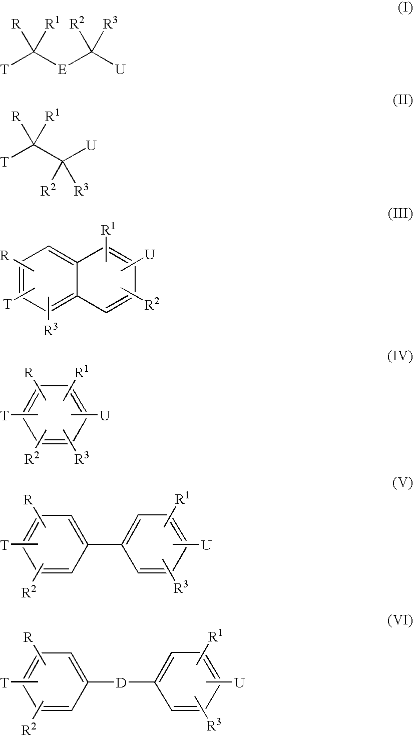

In each of formulae (I) to (VI), R, R¹, R², R³, R⁴ and R⁵ are independently selected from hydrogen, halogen, C₁ to C₁₄ alkyl, C₆ to C₁₈ aryl, C₁ to C₁₄ alkoxy and C₆ to C₁₈ aryloxy. More preferably the substituents R, R¹, R², R³, R⁴ and R⁵ are independently selected from hydrogen, chlorine, bromine, C₁ to C₉ alkyl, C₁ to C₉ alkoxy, C₆ to C₁₅ aryl and C₆ to C₁₅ aryloxy. In each formulae (II) to (VI) at least one of R, R¹, R², R³, R⁴ and R⁵ must be other than hydrogen.

In each of formulae (I) to (VI), T and U are independently selected from hydroxyl (OH) and carboxyl (COOH) functional groups and derivatives thereof. For instance, T and U may be independently selected from C₁ to C₆ alkyl ether and C₁ to C₆ alkyl ester moieties. At least one of T and U is hydroxyl or a derivative functional group. The complementary component may be a diacid analogue of the compounds represented by formulae (I) to (VI).

In formula (I), E may be selected from alkylene, arylene, alkylenoxy, alkylenedioxy, aryleneoxy and arylenedioxy. Preferably the group E is selected from C₁ to C₁₈ alkylene, C₆ to C₁₈ arylene, C₁ to C₁₈ alkylenoxy, C₁ to C₁₈ alkylenedioxy, C₆ to C₁₈ aryleneoxy and C₆ to C₁₈ arylenedioxy. More preferably the group E is selected from C₁ to C₁₂ alkylene, C₆ to C₁₂ arylene, C₁ to C₁₂ alkylenoxy, C₁ to C₁₂ akylenedioxy, C₆ to C₁₂ aryleneoxy and C₆ to C₁₂ arylenedioxy.

In formula (VI), D is selected from alkylene, —O—, —S—, —SO— and —SO₂—. Preferably the group D is selected from C₁ to C₁₀ alkylene, —O—, —S—, —SO— and —SO₂—.

Herein all alkyl groups and alkyl-containing moieties, such as alkoxy and alkylene, may be straight-chain or branched-chain.

All groups and moieties mentioned above for the groups R-R⁵ may, where possible, be optionally substituted with one or more C₁-C₆ alkyl, C₆-C₁₂ aryl, C₁-C₆ alkoxy, C₆-C₁₂ aryloxy, nitrile and halogen.

Exemplary compounds of formula (I) include 2-methyl-1,3-propanediol, 2,4-pentanediol, 2,2-dimethyl-1,3-propanediol, 2,2-diethyl-1,3-propanediol, 2-methyl-2-ethyl-1,3-propanediol, 2-methyl-2-propyl-1,3-propanediol, 2-ethyl-2-isobutyl-1,3-propanediol, 2-ethyl-2-butyl-1,3-propanediol, 2,2-diphenyl-1,3-propanediol, 3,3-dimethyl-4-hydroxy-butanoic acid, 2,4-dimethyl-2-ethylhexane-1,3-diol, 2,2,4-trimethyl-1,3-pentanediol, 2,5-dimethyl-2,5-hexanediol, 2,4-dimethyl-2,4-pentanediol, 1,4-bis(2-hydroxypropyl)benzene, 1,3-bis(2-hydroxypropyl)benzene, 1,4-bis(1-hydroxy-2-methylpropyl)benzene, 1,3-bis(2,2-dimethyl-1-hydroxy-ethyl)benzene, 2,2,4,4-tetramethyl-1,5-pentanediol, 2,2,5,5-tetramethyl-1,6-hexanediol, 2,2,4-trimethyl-1,4-pentanediol, 2,2,5-trimethyl-1,5-hexanediol and 2-ethyl-1,3-hexanediol.

Exemplary compounds of formula (II) include 2-methyl-1,2-propanediol, 2,3-butanediol, 2-methyl-2,3-butanediol, 2,3-dimethyl-2,3-butanediol, 3-hydroxy-butanoic acid and 2,2-dimethyl-3-hydroxy-butanoic acid.

Exemplary compounds of formula (III) include 1,3,5,7-tetramethyl-2,6-naphthalenediol, 1,3,6,8-tetramethyl-2,7-naphthalenediol, 2,5-, 2,6-, or 2,7-bis(2-hydroxypropyl)naphthalene and 2,5-, 2,6-, or 2,7-bis(1-hydroxy-2-methylpropyl)naphthalene.

Exemplary compounds of formula (IV) include 2,3,5,6-tetramethyl-hydroquinone, 2,4,6-trimethyl-1,3-dihydroxybenzene, 2,5-di-tert-butyl-hydroquinone.

Exemplary compounds of formula (V) include 3,3′,5,5′-tetramethyl-4,4′-biphenol 3,3′,5,5′-tetra-tert-butyl-4,4′-biphenol, 3,3′,5,5′-tetramethyl-4,4′-dicarboxy-biphenyl and, 3,3′,5,5′-tetra-tert-butyl-4,4′-dicarboxy-biphenyl and all isomers thereof.

Exemplary compounds of formula (VI) include 4,4′-methylene-bis-(2,6-di-methylphenol) 4,4′-methylene-bis-(2,6-di-tert-butylphenol) 2,2′-methylene-bis(4-methyl-6-tert-butyl-phenol) 2,2′-methylene-bis(4-ethyl-6-tert-butyl-phenol) 2,2′-thio-bis-(4-methyl-6-tert-butyl phenol) and the sulphone derivative thereof, 1,1′-thiobis(2-naphthol) and the sulphone derivative thereof, 2,2′-ethylene-bis-(2,6-di-tert-butyl-phenol) 2,2′-methylene-bis[6-(1-methylcyclohexyl)p-cresol] 2,2-di(3-methyl-4-hydroxyphenyl)propane 4,4′-thio-bis(6-tert-butyl-m-cresol) and the sulphone derivative thereof and 4,4′-butylidene-bis(6-tert-butyl-m-cresol), and all isomers thereof.

Other suitable compounds which fall outside the above formulae include 2-hydroxyisobutyric acid and 2,3,5,6-tetramethyl-1,4-cyclohexanediol, and all isomers thereof and 2,2,4,4-tetramethyl-1,3-cyclobutanediol, bis(hydroxyethyl)resorcinol and all isomers thereof.

When the hydroxyl group of the alcohol is attached to a primary aliphatic residue, i.e. the alcohol is of the form —CH₂OH, the adjacent carbon centre is preferably quaternary, as in neopentyl glycol. A preferred alcohol is neopentyl glycol.

Branched transesterification resistant polyesters may also be prepared from alcohols that exhibit the capacity to introduce branching. Such compounds will undergo typical polycondensation reactions and contain three or more carboxy, hydroxy, carboxy-hydroxy functional groups, or their respective ether or ester derivatives. Examples of suitable compounds include 1,1,3-tris(5-tert-butyl-4-hydroxy-2-methyl-phenyl)butane, 3-hydroxy-3-methyl glutaric acid, 4,4-bis(4-hydroxyphenyl)valeric acid, 2,4-dimethyl-2,4-dihydroxy-3-(2-hydroxy-propyl)pentane and 2,4,6-tri(3,5-di-tert-butyl-4-hydroxy-benzyl) mesitylene.

Exemplary complementary components include 2,2-dimethylmalonic acid, 3,3-dimethyl-1,5-pentanedioic acid, 2,2,5,5-tetramethyl-1,6-hexanedioic acid, 2,2-dimethyl-butanedioic acid, 2,2,3,3-tetramethyl-butanedioic acid, 1,3,5,7-tetramethyl-2,6-naphthalene dicarboxylic acid, 1,3,6,8-tetramethyl-2,7-naphthalene dicarboxylic acid, 3,3′,5,5′-tetramethyl-4,4′-dicarboxy-biphenyl and isomers thereof, and 3,3′,5,5′-tetra-tert-butyl-4,4′-dicarboxy-biphenyl and isomers thereof.

The complimentary component may also be selected from those found in conventional polyesters or polycarbonates. For example, the complimentary species may be selected from isophthalic acid, 2,6-naphthalene-dicarboxylic acid, resorcinol dioxyacetic acid, 4-hydroxybutyric acid, 5-hydroxypentanoic acid, 6-hydroxyhexanoic acid and 4-hydroxybenzoic acid.

Preferred precursor polyesters include those in which the transesterification resistance block is composed predominantly (>90 mole %) of neopentyl glycol or bis(hydroxyethyl) resorcinol as the diol component with isophthalic acid, 2,6-naphthalene-dicarboxylic acid, resorcinoldioxyacetic acid or a combination thereof as the diacid component. The precursor polyester may be depicted in general terms by the formula:

E-[-[A-B]ₐ-[C-D]_{b}-]_{c}-F

where A is a moiety derived from a diol, B is a moiety derived from a diacid, or the group -A-B- is a moiety derived from an acid-alcohol, C is a moiety derived from a diol, D is a moiety derived from a diacid, or the group —C-D- is a moiety derived from an acid-alcohol, and C and, optionally, D are chosen so as to confer transesterification resistance on [C-D]_{b}, E is H, a residue of B or a [C-D]_{b} segment, U is OH, a residue of C or a [A-B]ₐ segment, or E and/or F may be designed to facilitate incorporation, a is the average length of the transesterifiable segment (if present), b is the average length of the transesterification resistant block and c is the average number of segments in the chain.

The present invention further provides a process for preparing a composition which comprises reacting a precursor polyester comprising at least one transesterification resistant segment with another polyester and/or monomer, wherein the transesterification resistance of the segment is attributed to an alcohol from which the precursor polyester is derived. The precursor polyester can be prepared using conventional methodology.

The precursor polyester may be prepared by any conventional technique for the preparation of a polyester. The precursor polyester can be prepared from any alcohol or alcohol-acid monomer, or any combinations thereof that will provide steric hindrance in close proximity to the ester moiety. Sufficient steric hindrance can be afforded to the ester moiety by delivering such hindrance from the oxo side of the ester linkage, for example, a precursor polyester comprising the reaction residue from 2,2-dimethyl-1,3-propanediol and isophthalic acid. Furthermore, the precursor polyester may be prepared in such a way as to segment the transesterification resistant segments within a readily transesterifiable polyester.

An example of a precursor polyester transesterification resistant segment that can be used to prepare a block copolyester in accordance with the invention is a low molecular weight polyester of formula (VII), where z falls in the range 5 to 30.

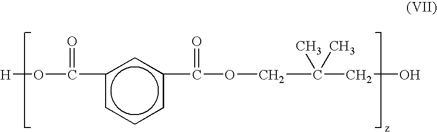

This precursor may be prepared by reacting the appropriate diacid, diol or acid-alcohol within a reactor vessel equipped with a stirrer, nitrogen gas inlet port and a condenser. A condensation catalyst such as butylhydrooxostanane is usually added to the reaction mixture. Other typical condensation catalysts include Lewis acids such as antimony trioxide, titanium dioxide, germanium dioxide and dibutyltin dilaurate. The reaction mixture is then heated to approximately 240° C. for several hours under a nitrogen atmosphere. Condensate is continuously distilled out during this period. Upon removing the majority of volatile components the reaction can proceed further by increasing the temperature up to approximately 270° C. and applying a vacuum for several hours. Additional reagents may be added to the vessel at any stage during the reaction in order to modify the polyester. Additional reagents capable of reacting with —COOH, —OH moieties or their respective ester derivatives can be added to modify end group functionality of the polyester. Such reactants may include anhydride, epoxy, oxazoline, lactam, primary or secondary amino, thiol derivatives and the like. Segmented precursor polyesters may be prepared by adding other transesterifiable polyesters and/or monomers to the vessel at any stage during the reaction. Branched polyesters comprising a transesterification resistant segment may be prepared by adding suitable polyfunctional carboxy, hydroxy, carboxy-hydroxy reagents to the vessel at any stage during the reaction. The resulting precursor polyester may be the final product or it can be utilised to prepare block copolyesters in accordance with the invention (or further block copolyesters as the case may be) through additional polycondensation reactions, melt processing, solid-stating, or any combination thereof.

Another example of a useful precursor polyester that can be used to prepare a block copolyester in accordance with the present invention is a high molecular weight block copolyester of formula (VIII):

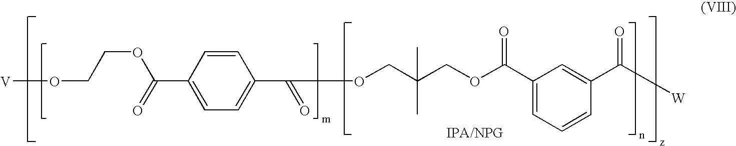

in which V is hydrogen or a terephthalic acid residue or an isophthalic acid/neopentyl glycol (IPA/NPG) derived segment and W is OH or a neopentyl glycol residue or a terephthalic acid/ethylene glycol (TPA/EG) derived segment, n is the average length of the transesterification resistant segment (in this case IPA/NPG) blocks, m is the average length of the transesterifiable segment (in this case TPA/EG) and z is the average number of segments in the chain. Typically m is 100, n is 15 and z is 1.

Polyesters which are composed entirely of transesterification resistant segments are often slower to incorporate than analogous polyesters made up of non-transesterification resistant segments. The rate of incorporation is also dependent on the end groups of the copolyester.

For example, an IPA/NPG precursor polyester (formula (IX)) wherein the NPG unit confers transesterification resistance is slower to incorporate than a corresponding IPA/EG copolyester (formula (X))

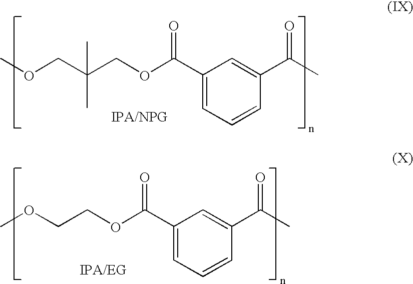

It has also been found that an IPA/NPG precursor polyester with IPA derived ends (formula (XI)) (acid end capped) is also more readily incorporated than the corresponding precursor polyester with NPG derived chain ends (formula (XII)) (hydroxyl end capped). Thus for ease of incorporation it is preferred that the precursor polyester where possible be prepared such that the chain ends are derived from the complementary monomer (not that which confers the transesterification resistance).

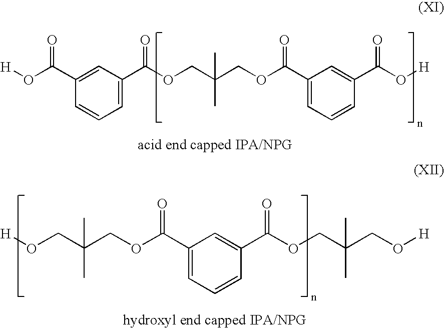

It is also possible to modify the chain ends to facilitate incorporation. For example, the hydroxyl end capped IPA/NPG precursor polyester may be reacted with pyromelltic dianhydride (PMDA) to form an anhydride end capped precursor polyester. This has the added advantage of reducing or eliminating the molecular weight reduction that accompanies blending of a low molecular weight precursor polyester with a high molecular weight polyester (e.g. PET). As another example the IPA (acid) end capped precursor polyester may be converted to an ethylene glycol (EG) end-capped polyester either by alcoholysis with EG or by reaction with ethylene oxide. A variety of other end group modification reactions may also be used to introduce reactive end groups. Preferred reactive end groups include hydroxy, carboxylic acid, anhydride, epoxy, thio, primary or secondary amino, N-oxazoline, lactam and isocyanate.

It is also possible to facilitate incorporation of the transesterification resistant precursor polyester through the use of coupling agents. Preferably these are added at a level of between one or two molar equivalents with respect to the moles of precursor polyester.

Monomers which may themselves impart functionality to the resultant block copolyester include bis(hydroxyethyl) resorcinol, 4-hydroxybenzoic acid, resorcinol dioxyacetic acid, isophthalic acid and 2,6-naphthalene dicarboxylic acid. These monomers may impart useful properties such as barrier/gas permeability. The individual components may be combined as part of a conventional polycondensation process used to form copolyesters. Such a process can include the addition of other polyester(s) and/or monomer(s) to the reaction vessel used to prepare the polyester product.

Usually the polyester combined with the precursor polyester is thermoplastic. Thermoplastic polyesters include hetero-chain macromolecular compounds that possess repeat carboxylate ester groups in the backbone of the polymer. Preferred polyesters for use in the present invention include polyalkylene terephthalates, e.g. PET, poly(propylene terephthalate)(PPT) and poly(butylene terephthalate) (PBT), poly(cyclohexylenedimethanol terephthalate), poly(alkylene isophthalates), poly(alkylene 2,6-naphthalenedicarboxylates), particularly PEN, polycaprolactones, poly(4-hydroxybutyric acid), liquid crystalline polyesters (LCP) and polyesters of carbonic acid (polycarbonates) and copolymers and blends of two or more thereof.

Thermoplastic resins such as polyethylene terephthalate, polypropylene terephthalate and polybutylene terephthalate may impart good mechanical characteristics, heat resistance, and dimensional stability. These polyesters also have good processability and are widely used in extrusion, melt-spinning, injection moulding and stretch-blow moulding to produce a variety of products. Such polyesters, or derivatives of them, may be combined with the precursor polyester with the intention of taking advantage of these properties.

Copolymers, for instance of PET, may also be used and include variants containing other comonomers. For example, when using PET, some of the ethanediol may be replaced with other diols such as cyclohexanedimethanol or bis(hydroxyethyl)resorcinol to form a copolymer, similarly the terephthalic acid may be replaced with isophthalic acid or NDA to form a copolymer. A preferred copolymer of PET is a copolymer of PET in which some of the terephthalic acid is substituted with isophthalic acid. Copolymers of PBT or PEN may be similarly constructed.

Useful liquid crystalline polyesters include poly(hydroxybenzoic acid) (HBA), poly(2-hydroxy-6-naphthoic acid) and poly(naphthalene terephthalate) (PNT) which is a copolymer of 2,6-dihydroxynaphthalene and terephthalic acid). Copolymers of liquid crystal polyesters with other polyesters are also suitable for use in the present invention.

Of particular advantage in the present invention is the selection of monomers units that are used to prepare the precursor polyester. The monomeric units can be used to impart useful properties in the final polyester composition such as improved barrier properties, improved thermal properties and improved mechanical properties etc. Preferred monomeric units that can be incorporated within the transesterification resistant segment(s) of the precursor polyester include 2,6-naphthalene-dicarboxylic acids and alcohol derivatives, biphenyl acids and alcohol derivatives, diphenyl alkylene acids and alcohol derivatives and phenyl-containing acids and alcohol derivatives.

Other monomeric units that can be incorporated within the transesterification resistant segment(s) of the precursor polyester include isophthalic acid, resorcinol dioxyacetic acid and all isomers thereof, bis(hydroxyethyl)resorcinol and all isomers thereof, 4,4′-biphenol and all isomers thereof, 4,4-dicarboxy-biphenyl and all isomers thereof, 4,4′-thio-bis(phenol) and the sulphone derivative and all isomers thereof, 4,4′-thio-bis(benzoic acid) and the sulphone derivative and all isomers thereof, 1,1′-thiobis(2-naphthol) and the sulphone derivative and all isomers thereof, 1,1′-thiobis(2-naphthalenecarboxylic acid) and the sulphone derivative and all isomers thereof.

Alternatively, the precursor polyester can be subjected to further polycondensation reaction(s) in a cascade fashion with other (typically thermoplastic) polyester(s) and/or monomer(s), during which reactions the precursor polyester (or copolyester) retains its block character.

A precursor polyester may be conveniently utilised within melt processing process(es) to form a polyester composition. The precursor polyester may be melt processed with other thermoplastic polyester(s) and/or monomer(s), as described.

Melt processing may conveniently be achieved by continuous extrusion equipment such as twin screw extruders, single screw extruders, other multiple screw extruders and Farell mixers. Semi-continuous or batch polymer processing equipment may also be used to achieve melt mixing. Suitable equipment includes injection moulders, Banbury mixers, batch mixers and static mixers.

A precursor polyester may be conveniently utilised within solid stating process(es) to form a block copolyesters. The precursor polyester may or may not be melt processed with other thermoplastic polyester(s) and/or monomer(s) prior to the solid stating process(es). Conventional solid-stating equipment and conditions may be used, as would be known to a person skilled in the art.

The length(s) of the transesterification resistant segment(s) block(s) within a block copolyester formed in accordance with the present invention may be controlled by either the segment(s) length(s) of the precursor polyester or by the selection of the processing conditions used during the course of the reaction forming the block copolyester i.e. usually polycondensation, melt processing, solid-stating processes, or any combination thereof, or by the addition of a condensation catalyst during manufacture, or a combination of two or more of these. Both physical and chemical properties of the block copolyester formed in accordance with the present invention can also be altered through choice of block length and/or the respective monomeric units that are used to prepare the precursor polyester segment(s).

If upon incorporation of the precursor polyester by process(es) such as polycondensation, melt processing, solid-stating, or any combinations thereof, the molecular weight of the resulting block copolyester is lower than desired, additional reagents can be added to improve properties of the polymer such as melt viscosity, molecular weight, impact strength and the like. The additional reagents may be added to the polyester for reaction, be that simultaneously or sequentially, and either before, during or after the polyester has melted or during a second melting or solid-stating process after initial modification. These sequenced additions may be used to control the structure as well as the performance of the resultant polymer.

The transesterification resistance may also be enhanced by use of the kind of transesterification inhibitors described above, i.e. by combining the precursor polyester and the another polyester and/or monomer in the presence of an added reagent such as a phosphate. Additionally, or as an alternative, the extent of transesterification may be minimised by selection of more suitable processing conditions such as lowering the process temperature or reducing the residence time when the material is subjected to high temperature.

In another aspect the invention provides a process for modifying a polyester which comprises combining the polyester with a precursor polyester comprising at least one transesterification resistant segment as described herein. The reaction may be a polycondensation, melt processing, solid stating or any combination thereof. By this modification the structure, and hence the properties of the resultant copolyester, may be suitably manipulated. Thus, desirable physical and/or chemical properties may be imparted by a moiety present in a transesterification resistant block. More specifically the present invention may allow production of copolyesters with improved barrier properties, improved heat distortion temperature, improved flame retardancy, reduced flammability, improved biodegradability, improved surface properties, improved impact strength, improved tensile strength, improved modulus, and/or improved rheology. In that the block is transesterification resistant these properties will not be impaired by melt processing, solid stating or like processes. When the reaction is a polycondensation it is desirable that the precursor polyester is added toward the latter stages thereof in order to minimise the extent of any transesterification rections.

Functionality having an impact on the properties of the polyester composition may be incorporated into the transesterification resistant segment. Such funtionality includes oxygen scavengers, for example those disclosed in U.S. Pat. No. 6,083,585, light stabilisers, antioxidants, agents to assist biodegradation either as pendant or inchain groups. This has the advantage that the functionality may be localised in the amorphous phase of the polyester thus enhancing its effectiveness. Other monomers or segments, for example those based on tetramethylcyclobutanedimethanol may impart improved heat distortion temperature.

Block copolyesters prepared using the precursor polyester as described herein are typically of formula (XI):

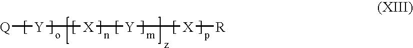

wherein each X is a transesterification resistant polyester repeat unit which may be the same or different; each Y is a transesterifiable polyester repeat unit which may be the same or different; Q and R are end groups independently selected from —COOH, —OH or their ester or ether derivatives, functional groups that may react with —COOH, —OH, ester or ether moieties, such an anhydride, cyano, epoxide and the like; m and n are each independently integers from 2 to 498, o and p are each independently integers from 0 to 498 provided o+p≦500 and z is an integer ≧1 such that o+p+(n+m)z≦500, and wherein the average sequence distribution of [X]n within [Y]m is greater than that obtained when a compositionally equivalent copolyester is prepared by conventional polycondensation techniques.

The average sequence distribution of a particular comonomer within a given polyester prepared by polycondensation can be calculated. One method for calculating the average sequence distribution uses the following formula:

$${\overline{N}}_{n , BB} = \frac{1}{1 - {r}_{1} {q}_{2}^{2}}$$

(Comprehensive Polymer Science, volume 5, page 256, Pergamon Press Plc., 1989.) This formula is based on the following definition of the average comonomer sequence length:

-AA-BB-AA-BB-AA-BB-AA-CC-AA-CC-AA-

Where the sequence length of BB is 3 and that of CC is 2. In this example the monomer AA can react with monomers BB and CC, but BB has no appreciable reactivity towards CC, or vice versa, and r₁=B₀/A₀, where B₀ and A₀ are the concentrations of the monomers BB and AA at time 0 and

$${q}_{2} = \frac{{C}_{0} - C}{{C}_{0}}$$

Where C₀ is the concentration of monomer CC at time 0 and C is the concentration of CC at time t.

It can be shown that upon consumption of monomers AA, BB and CC in a given polycondensation reaction the average sequence distribution of a particular monomer (in this case BB) can be expressed as follows:

$${\overline{N}}_{n , BB} = \frac{1}{{C}_{0}}$$

For example, where AA=terephthalic acid (TPA)

BB=neopentylgylcol (NPG)

CC=ethyleneglycol (EG)

the average sequence distribution of NPG within a polyester prepared by polycondensation having a composition of 100 mol % TPA, 50 mol % NPG and 50 mol % EG can be calculated as follows:

$${\overline{N}}_{n , BB} = \frac{1}{{C}_{0}} = \frac{1}{0.5} = 2$$

Therefore, the average sequence distribution of NPG in the polyester is greater than 2. However, the length of the sequence distribution in block copolyesters prepared by the process of the current invention will be primarily dictated by the sequence length of the transesterification resistant block(s) of the precursor polyester used in the process. The present invention therefore enables preparation of polyesters having a larger sequence distribution than those prepared by conventional polycondensation. Techniques such as NMR may be used to evaluate such sequence distribution lengths. This is within the ability of one skilled in the art.

In an embodiment of the invention the precursor polyester, and the another polyester and/or monomer, are reacted in the presence of a coupling agent. The coupling agent aids incorporation of the transesterification resistant segment present in the precursor polyester in the resultant block copolyester product. Coupling agents which may be used include polyfunctional acid anhydrides, epoxy compounds, oxazoline derivatives, oxazolinone derivatives, lactams and related species. For examples of additional coupling agents we refer to Inata and Matsumura, J. App. Pol. Sci., 303325 (1988) and Lootjens et al J. App. Pol. Sci 65 1813 (1997) and Brown in “Reactive Extrusion” Ed Xanthos, Hanger, New York 1992 p75. Coupling agents for use in the current invention also include species that act as dehydrating agents that may or may not be directly incorporated into the polyester.

Those containing anhydride or lactam units are preferred for reaction with alcohol functionality. Those containing oxazoline, oxazolinone, epoxide, carbodimide units are preferred for reaction with acid functionality.

Preferred coupling agents which may be used alone or in combination include the following:

(1) Polyepoxides such as bis(3,4-epoxycyclohexylmethyl) adipate; N,N-diglycidyl benzamide (and related diepoxies); N,N-diglycidyl aniline and derivatives; N,N-diglycidylhydantoin, uracil, barbituric acid or isocyanuric acid derivatives; N,N-diglycidyl diimides; N,N-diglycidyl imidazolones; epoxy novolaks; phenyl glycidyl ether; diethyleneglycol diglycidyl ether; Epikote 815 (diglycidyl ether of bisphenol A-epichlorohydrin oligomer).

(2) Polyoxazolines/Polyoxazolones such as 2,2-bis(2-oxazoline); 1,3-phenylene bis(2-oxazoline-2), 1,2-bis(2-oxazolinyl-2)ethane; 2-phenyl-1,3-oxazoline; 2,2′-bis(5,6-dihydro-4H-1,3-oxazoline); N,N′-hexamethylenebis(carbamoyl-2-oxazoline; bis[5(4H)-oxazolone); bis(4H-3,1benzoxazin-4-one); 2,2′-bis(H-3,1-benzozin-4-one);

(3) Polyisocyanates such as 4,4′-methylenebis(phenyl isocyanate) (MDI); toluene diisocyanate, isocyanate terminated polyurethanes; isocyanate terminated polymers;

(4) Anhydrides

Examples of polyfunctional acid anhydrides include aromatic acid anhydrides, cyclic aliphatic anhydrides, halogenated acid anhydrides, pyromellitic dianhydride, benzophenonetetracarboxylic acid dianhydride, cyclopentanetetracarboxylic dianhydride, diphenyl sulphone tetracarboxylic dianhydride, 5-(2,5-dioxotetrahydro-3-furanyl)-3-methyl-3-cyclohexene-1,2-dicarboxylic dianhydride, bis(3,4-dicarboxyphenyl)ether dianhydride, bis(3,4-dicarboxyphenyl)thioether dianhydride, bisphenol-A bisether dianhydride, 2,2-bis(3,4-dicarboxyphenyl)hexafluoropropane dianhydride, 2,3,6,7-naphthalenetetracarboxylic acid dianhydride, bis(3,4-dicarboxyphenyl)sulphone dianhydride, 1,2,5,6-naphthalenetetracarboxylic acid dianhydride, 2,2′,3,3′-biphenyltetracarboxylic acid, hydroquinone bisether dianhydride, 3,4,9,10-perylene tetracarboxylic acid dianhydride, 1,2,3,4-cyclobutanetetracarboxylic acid dianhydride, 3,4-dicarboxy-1,2,3,4-tetrahydro-1-naphthalene-succinic acid dianhydride, bicyclo(2,2)oct-7-ene-2,3,5,6-tetracarboxylic acid dianhydride, tetrahydrofuran-2,3,4,5-tetracarboxylic acid dianhydride, 2,2-bis(3,4-dicarboxyphenyl)propane dianhydride, 3,3′,4,4′-biphenyltetracarboxylic acid dianhydride, 4,4′-oxydiphthalic dianhydride (ODPA), and ethylenediamine tetraacetic acid dianhydride (EDTAh). It is also possible to use acid anhydride containing polymers or copolymers as the acid anhydride component.

Preferred polyfunctional acid anhydrides include pyromellitic dianhydride, 1,2,3,4-cyclopentanetetracarboxylic acid dianhydride, 1,2,3,4-cyclobutanetetracarboxylic acid dianhydride and tetrahydrofuran-2,3,4,5-tetracarboxylic acid dianhydride. Most preferably the polyfunctional acid anhydride is pyromellitic dianhydride.

(5) Polyacyllactams such as N,N′-terephthaloylbis(caprolactam) and N,N-terephthaloylbis(laurolactam). The use of these and similar compounds for PET chain extension has been disclosed by Akkapeddi and Gervasi in U.S. Pat. No. 4,857,603.

(6) Phosphorous (III) coupling agents such as triphenyl phosphite (Jaques et al Polymer 38 5367 (1997)) and other compounds such as those disclosed by Aharoni in U.S. Pat. No. 5,326,830.

In another embodiment of the present invention, the polyester compositions arising from the present invention can be formed into an article such as a container, film, bottle or any similar receptacle that might be used for packaging materials, particularly receptacles used for packaging food and drink, and the invention also relates to such processing and conversion. The polyester compositions arising from the present invention can also be used in foaming applications, biodegradable applications, non-food contact containers and as engineering plastics. The precursor polyesters can also be used to modify the rheological properties of other polyester resins.

In another aspect, the present invention provides the use of a precursor polyester comprising at least one transesterification resistant segment in the manufacture of a polyester composition. The invention yet further provides a means of incorporating at least one transesterification resistant segment into a polyester composition by use of the precursor polyester.

In another embodiment the present invention relates to the use of certain polyester compositions. More specifically, the invention provides the use-of a polyester composition which is obtainable by combining a precursor polyester comprising at least one transesterification resistant segment with a monomer selected from at least one of bis (hydroxyethyl) resorcinol 2,2,4,4-tetramethylcyclobutanediol, 4-hydroxybenzoic acid, resorcinol dioxyacetic acid, isophthalic acid, 2,2-dimethylmalonic acid, 2,6-naphthalene dicarboxylic acid and alcohol derivatives thereof, biphenyl acids and alcohol derivatives thereof, diphenylalkylene acids and alcohol derivatives thereof, and combinations thereof.

In an alternative embodiment the invention also provides the use as a barrier material of a polyester composition which is obtainable by combining a precursor polyester comprising at least one transesterification segment with another polyester and/or monomer, wherein the transesterification resistant segment is derived from a monomer selected from at least one of bis(hydroxyethyl)resorcinol, 2,2,4,4-tetramethylcyclobutanediol, 4-hydroxybenzoic acid, resorcinol dioxyacetic acid, isophthalic acid, 2,2-dimethylmalonic acid, 2,6-naphthalene dicarboxylic acid and alcohol derivatives thereof, biphenyl acids and alcohol derivatives thereof, diphenylalkylene acids and alcohol derivatives thereof In this embodiment the polyester combined with the precursor polyester may be derived from one or more of the monomer species listed above. Similarly, the monomer combined with the precursor polyester may be selected from one or more of these monomer species.

In these embodiments it is essential that the polyester composition includes units derived from a monomer which confers desirable barrier properties. In these embodiments the precursor polyester may be prepared by reacting an acid and alcohol (or alcohol-acid), either or both contributing the requisite transesterification resistance. Useful acids and alcohols are described above as is the general synthetic process by which the precursor polyester and polyester composition may be prepared.

The invention will now be described with reference to the following examples in which molecular weights were determined by GPC analysis using either THF (precursor polyesters) or 90:10 chloroform:hexafluoroisopropanol as the eluent and ¹H NMR spectra were obtained with a Bruker Avance DRX500 on samples dissolved in 1:1 deuterochroroform:deuterotrifluroacetic acid.

### EXAMPLES 1-11

### Synthesis of Precursor Polyesters

A series of precursor polyesters have been prepared based on the use of neopentyl glycol or bis(hydroxyethyl)resorcinol as the diol component to confer transesterification resistance. Polyesters based on ethylene glycol based copolyesters have been prepared to provide comparative examples (Examples 5,6). Random copolyesters containing small amounts of ethylene glycol (<10%) have been prepared to control the segment length of the transesterification resistant block (Examples 2-4).

The following procedure is typical.

Neopentyl glycol (380 g) and catalyst (butylhydroxyoxostannane) (2.5 g) were heated to 80° C. under nitrogen in a 500 mL flanged flask equipped with mechanical stirrer, insulated fractionating column and stillhead, and thermocouple. Isophthalic acid (251 g) was added portionwise with stirring (approximately 150 rpm). The temperature of the mixture was slowly ramped up to 240° C. After 1 hr. the temperature had risen to about 170° C. and the condensate had started to distil (b.p. 100° C.). When 56 ml of condensate had distilled and the temperature at the stillhead had began to fall (ca. 6 hours) the molten polyester was poured from the reaction flask and allowed to cool.

The summary of precursor polyesters prepared by this procedure is provided in Table 1. the end group functionality of the precursor polyester is adjusted by controlling the stoichiometry of the reaction and confirmed by ¹H NMR analysis. Molecular weights were determined by GPC analysis and are reported in polystyrene equivalents.

TABLE 1
Precursor polyesters prepared by polycondensation

| | | | End | |
|---|---|---|---|---|
| Example | Glycol^{a} | Diacid^{b} | Groups^{c} | M_{ₙ} |
| 1 | NPG | IPA | OH | 4200 |
| 2 | EG-NPG (2:48) | IPA | OH | 3200 |
| 3 | EG-NPG(6:44) | IPA | OH | 3600 |
| 4 | EG-NPG(9:41) | IPA | OH | 3900 |
| 5 | EG | IPA | H | 7000 |
| 6 | EG-HER(31:19) | IPA | H | 4300 |
| 7 | NPG-HER(31:19) | IPA | H | 3500 |
| 8 | HER | IPA | H | 3600 |
| 9 | NPG | NDC | — | 2300 |
| 10 | EG | NDC | — | 4000 |
| 11 | NPG-HER-BP | IPA-NDA-RDOA | — | 4100 |
| | (40:5:5) | (40:5:5) | | |

^{a}NPG = neopentyl glycol,
EG = ethylene glycol,
HER = bis(hydroxyethylresorcinol),
BP = 4,4′-biphenol (ratio of components given in parentheses)
^{b}IPA = isophthalic acid,
NDA = 2,6-naphthalene dicarboxylic acid,
RDOA = resorcinol dioxyacetic acid (ratio of components given in parentheses)
^{c}OH = glycol end capped,
H = diacid end capped,
— = not determined.

### EXAMPLE 12

### Synthesis of Anhydride End Capped Precursor Polyester

A solution of neopentyl glycol end capped IPA/NPG (Mₙ 8100) in toluene was heated under reflux with a slight excess of pyromellitic dianhydride for 8 h. Complete reaction was indicated by disappearance of signals attributed to the methylene adjacent to the hydroxyl end group. The solvent was removed by evaporation under vacuum.

### EXAMPLES 13-15

### Preparation of Polyester Compositions on Batch Mixer

In examples 12-14 precursor polyesters were combined with a commercial polyethylene terephthalate homopolymer (Eastman 9663, IV=0.81)) using a Brabender batch mixer.

### EXAMPLE 13

A commercial polyester (13 g) derived from the reaction residue of isophthalic acid and neopentyl glycol (polystyrene equivalent molecular weight of Mₙ=8100, hydroxyl value of 30 mg KOH/g) was melt blended with a commercial bottle grade PET (52 g) resin (IV=0.81) at 290° C. for 20 minutes at 20 RPM using a Brabender batch mixer.

### EXAMPLE 14

A commercial polyester (13 g) derived from the reaction residue of isophthalic acid and neopentyl glycol (polystyrene equivalent molecular weight of Mₙ=7900, acid value of 30 mg KOH/g) was melt blended with a commercial bottle grade PET (52 g) resin (IV=0.81) at 290° C. for 20 minutes at 20 RPM using a Brabender batch mixer.

### EXAMPLE 15 (COMPARATIVE)

A polyester (13 g) (example 5) derived from the reaction residue of isophthalic acid and ethylene glycol (polystyrene equivalent molecular weight of Mₙ=7000, >90% acid capped) was melt blended with a commercial bottle grade PET (52 g) resin (IV=0.81) at 290° C. for 20 minutes at 20 RPM using a Brabender batch mixer.

The copolyester was cryoground into a powder and extracted with boiling chloroform for 15 hours. The extraction residue was weighed and the extract analysed by ¹H NMR.

TABLE 2
Polyester compositions formed on brabender batch mixer

| Example | Precursor polyester^{a} | % extractables | transesterification |
|---|---|---|---|
| 13 | IPA/NPG-OH | 21^{b} | a |
| 14 | IPA/NPG-H | 9^{b} | b |
| 15 | IPA/EG-H | 12^{c} | c |

^{a}IPA/NPG-H = isophthalic acid capped IPA/NPG copolyester,
IPA/NPG-OH = neopentyl glycol capped IPA/NPG copolyester,
IPA/EG-H = isophthalic acid capped IP A/EG copolyester.
^{b}extract is mainly unchanged precursor
^{c}extract is low molecular weight IPA-TPA/EG copolyester.

### EXAMPLES 16-33

### Preparation of Polyester Compositions on Twin Screw Extruder

These examples demonstrate the synthesis of block copolyesters from transesterification resistant precursor polyesters by a melt mixing process. Under condition where IPA/EG undergoes extensive transesterification, the transesterification resistant IPA/NPG precursors are incorporated largely intact to form block copolyesters.

Experiments were performed on a JSW TEX 30 twin screw extruder having a 30 mm screw diameter and an overall L/D of 42 [comprising ten temperature controlled barrel sections of L/D 3.5, three unheated sampling monitoring blocks of L/D 1.167 and a cooled feed block of L/D 3.5]. The screw design consisted of kneading, conveying and reversing elements familiar to those skilled in the art. The extruder was operated in co-rotating (intermeshing self wiping) modes with throughputs of 1 or 2 kg/hr and a screw speed of 37 rpm. The barrel section temperatures were set between 160° and 290° C. A typical barrel profile is as follows: zone 1 160°, zone 2-9 270°. The melt temperatures and pressures were monitored at three points along the barrel as well as in the die. The extrudate was collected and cooled by passing along a conveyor belt and then cut into pellets using an automated cutter. The PET and the precursor polyester were fed into the extruder using a JSW TTF20 gravimetric feeder and a K-Tron KQX gravimetric feeder respectively. The PET was dried in a desiccant drier system to <40 ppm H2O. The oligomeric material was cryoground to a powder and dried in a vacuum oven.

The following table documents the ratios of PET to precursor polyester used in the examples estimates of the extent of incorporation and extent of transesterification the of precursor polyester into the PET chains as determined by NMR are also presented. The incorporation of the precursor polyester IPA/NPG-H was determined from the integrals of the triplets at δ 7.72 and δ 7.63 representing the meta-proton of the isophthalate repeat unit and end group respectively. For IPA/NPG-OH incorporation was determined from the integrals of the peaks at δ 1.19 and δ 1.27 representing the methyl protons of the neopentyl end group and repeat unit respectively. For IPA/EG-H the incorporation and extent of transesterification was determined by observation of the triplet at δ 7.62 representing the ortho-proton of the isophthalate repeat unit. (see Ha et al J. Polym. Sci, Part B, 35, 309 (1997)).

TABLE 3
Polyester Compositions formed on twin screw extruder

| | | | wt % | Through- | | |
|---|---|---|---|---|---|---|
| | Wt % | Precursor | Precursor | put | | transester- |
| Example | PET | polyester^{a} | polyester | (Kg/h) | incorporation^{b} | ification |
| 16 | 95 | EPA/NPG-H | 5 | 1 | >90% | c |
| 17 | 90 | IPA/NPG-H | 10 | 1 | >90% | c |
| 18 | 85 | IPA/NPG-H | 15 | 1 | >90% | c |
| 19 | 80 | IPA/NPG-H | 20 | 1 | >90% | c |
| 20 | 70 | IPA/NPG-H | 30 | 1 | >90% | c |
| 21 | 90 | IPA/NPG-H | 10 | 2 | >90% | c |
| 22 | 95 | IPA/NPG-OH | 5 | 2 | >90% | c |
| 23 | 95 | IPA/NPG-OH | 5 | 1 | >90% | d |
| 24 | 90 | IPA/NPG-OH | 10 | 1 | >90% | d |
| 25 | 85 | IPA/NPG-OH | 15 | 1 | >90% | d |
| 26 | 80 | IPA/NPG-OH | 20 | 1 | ca. 80% | d |
| 27 | 70 | IPA/NPG-OH | 30 | 1 | ca. 75% | d |
| 28 | 95 | IPA/NPG-OH | 5 | 2 | >90% | d |
| 29 | 90 | IPA/NPG-OH | 10 | 2 | ca. 85% | d |
| 30 | 95 | IPA/EG-H | 5 | 1 | >90% | e |
| 31 | 90 | IPA/EG-H | 10 | 1 | >90% | e |
| 32 | 95 | IPA/EG-H | 5 | 2 | >90% | e |
| 33 | 90 | IPA/EG-H | 10 | 2 | >90% | e |

^{a}IPA/NPG-H = isophthalic acid capped IPA/NPG copolyester, IPA/NPG-OH = neopentyl glycol capped IPA/NPG copolyester, IPA/EG-H = isophthalic acid capped IPA/EG copolyester.
^{b}>90% indicates the signals attributable to end groups could not be detected by NMR
c Some evidence of transesterification from NMR (signal attributable to NPG-IPA-EG linkages of greater intensity than that due to IPA end groups in precursor polyester) Minimal signal due to EG-IPA-EG sequences. Estimated segment length >50% that of precursor polyester.
d No evidence of transesterification from NMR
e Extensive transesterification has occurred

These examples show that for IPA/NPG precursor polyesters, the NPG end capped precursor polyesters are more transesterification resistant when used in preparing polyester compositions in melt processing than analogous IPA end capped precursor polyesters. On the other hand, IPA end capped precursor polyesters are more readily incorporated than analogous NPG end capped precursor polyesters.

### EXAMPLES 34-38

### Preparation of Polyester Film Compositions using a Twin Screw Extruder

These examples demonstrate the synthesis of block copolyesters in accordance with the present invention using a melt mixing process. Amorphous films of compositions described in Table 4 for Oxtran analysis were prepared.

Experiments were performed on a JSW TEX 30 twin screw extruder having a 30 mm screw diameter and an overall L/D of 42 [comprising ten temperature controlled barrel sections of L/D 3.5, three unheated sampling monitoring blocks of L/D 1.167 and a cooled feed block of L/D 3.5]. The screw design consisted of kneading, conveying and reversing elements familiar to those skilled in the art. The extruder was operated in co-rotating (intermeshing self wiping) modes with throughputs of 5 kg/hr and a screw speed of 155 rpm. The barrel section temperatures were set between 20° and 280° C. A typical barrel profile is as follows: zone 1 20°, zone 2 120° zones 3-9 270°. The melt temperatures and pressures were monitored at three points along the barrel. The die was a ten-inch slot die with three controllable heating zones and adjustable lip width. Passing through chilled rollers at approximately 40° cooled the film extrudate. The PET and the precursor polyester were fed into the extruder using a JSW TTF20 gravimetric feeder and a K-Tron KQX gravimetric feeder respectively. The PET was dried in a desiccant drier system to <40 ppm H₂O. The precursor polyester was cryoground to a powder and dried in a vacuum oven.

The following table documents the ratios of PET to precursor polyester used in the examples and indicates the crystallinity able to be induced in the extrudate calculated after a slow step-wise quench from molten state in a Pyris 1 DSC furnace.

Around 5 mg of Samples were accurately weighed, crimped in aluminium pans and placed in a vacuum oven at 40° C. for more than 48 hours prior to measurement. A Pyris 1 DSC furnace was used for step-wise segregation technique (SIST) to determine crystallinity. The instrument was calibrated with indium and zinc standards for temperature and with indium for heat capacity.

Also listed in the following table are the oxygen transmission results as measured on a Mocon Oxtran 2-20 instrument.

TABLE 4
Oxygen transmission results from amorphous films produced by reactive extrusion
and the percentage of crystallinity able to be induced in extrudate.

| | | | | | | Transester- |
|---|---|---|---|---|---|---|
| | | | | | | ification |
| | Precursor | PET | % | Oxygen | | determined |
| | polyester | Mol | Crystal- | transmission | | by ¹H |
| Example | (10 mol %) | % | linity | (25 μmcc/m²/day) | Tₘ | NMR |
| 34 | RDOA-EG | 90 | 42 | 94 | 248.2 | e |
| 35 | RDOA-HER | 90 | 41 | 74 | 251.2 | b |
| 36 | IPA-HER | 90 | 40 | 89 | 251.5 | b |
| 37 | NDC-HER | 90 | 38 | 102 | 248.4 | c |
| 38 | RDOA-NPG | 90 | 36 | 89 | 252.2 | a |
| | — | 100 | 41 | 150 | 252.9 | |

a = very little or no evidence of transesterification
b = some evidence of transesterification
c = evidence of moderate transesterification
d = evidence of considerable transesterification
e = evidence of randomised or almost randomised copolyester

### EXAMPLES 39-50

### Synthesis of Precursor Polyesters

The following procedure is typical.

A wide necked 1 L RBF (round bottomed flask) was charged with resorcinol dioxyacetic acid (200.0 g, 0.884 mol) and neopentyl glycol (92.6 g, 0.889 mol) and a catalytic amount of p-toluenesulfonic acid (0.7 g, 4.1 mmol). The RBF was then fitted to a rotary evaporator and rotated in an oil bath at 150° C. under vacuum (pressure approx. 10 mm Hg) until all the contents were molten. The oil bath was then heated to around 200° C. and the vacuum increased by connected the rotary evaporator to an electric diaphragm pump (pressure approx. 1 mm Hg). The flask was rotated for a further 6 h and the contents then poured onto a polished metal sheet. The solidified product was then broken up and characterised. ¹H NMR: δ_{H} (CDCl₃/TFA 1:1, 500 MHz) 7.23 (1 H, m, arom), 6.57 (3H, m, arom), 4.75 (4H, s, arom-OCH₂), 4.12 (4H, s, CO₂CH₂C(CH₃)₂), 1.02 (6H, s. CH₃). GPC: Mₙ 6171, M_{w} 14417, M_{z} 23258.

The summary of precursor polyesters prepared by this procedure is provided in Table 5. The products were characterised by ¹H NMR analysis and molecular weights were determined by GPC analysis and are reported in polystyrene equivalents.

TABLE 5
Composition and Mₙ of precursor polyester examples 39-50.

| | | | End | |
|---|---|---|---|---|
| Example | Diol | Diacid | groups | Mₙ |
| 39 | EG | RDOA | H | 3151 |
| 40 | HER | RDOA | H | 4045 |
| 41 | NPG | RDOA | H | 6171 |
| 42 | HER | IPA | H | 4225 |
| 43 | TMCBD | IPA | H | 2395^{a} |
| 44 | TMCBD | RDOA | H | 2174 |
| 45 | HER | DMA | H | 2415 |
| 46 | CHD | RDOA | H | 3821 |
| 47 | CHDM | RDOA | H | 10009 |
| 48 | EG | NDC | H | 4080 |
| 49 | HER | NDC | H | 2448 |
| 50 | NPG | NDC | H | 3969 |

^{a}Mₙdetermined by ¹H NMR.
TMCBD = 2,2,4,4-Tetramethyl-1,3-cyclobutanediol;
CHD = 1,4-Cyclohexanediol;
CHDM = 1,4-Cyclohexanedimethanol;
DMA = 2,2-dimethylmalonic acid.

### EXAMPLES 51-53

### Analysis of Rates of Transesterification by DSC and NMR

A sample of PET homopolymer was cryoground and dried at 140° C., a sample of RDOA-NPG precursor polyester was cryoground and dried in a vacuum oven at room temperature. 10 g of PET powder was dissolved in 200 cm³ o-chlorophenol with heating (to around 100° C.); 6.07 g of RDOA-NPG (as per Example 41) was dissolved in 40 cm³ o-chlorophenol. 2.9 cm³ of the precursor polyester solution was combined with 51.2 cm³ of the PET solution. This solution was then poured into approximately 500 cm³ methanol to precipitate an intimately mixed solid of PET and RDOA-NPG. The resulting solid was collected by filtration and then extracted with methanol for 2 days in a Soxhlet extraction. The solid precipitate was then dried in a vacuum oven at room temperature overnight. The solid mass was then ground using a mortar and pestle and then replaced in the vacuum oven to dry for a further 2 days. The resulting product was then weighed into 100 μL Aluminium DSC crucibles for heat treatment in a DSC furnace (Mettler Toledo DSC 821^{e}) for varying periods of time at 300° C.

The four samples were held at 300° C. for 4, 32 128 and 256 minutes respectively and then rapidly quenched to room temperature. These samples were then taken from the DSC crucibles and dissolved in TFA/CDCl₃ (1:1) for ¹H NMR analysis. From the proton spectra thus obtained a calculation of number average sequence length of the precursor polyester was made and is represented in the table below.

The procedure was repeated for RDOA-HER (as per Example 40) and RDOA-EG (as per Example 39) precursor polyester for diol component comparison of transesterification rates.

TABLE 6
Number average sequence length of oligomeric polyesters
(at 10 mol %) level when combined with PET homopolymer
after varying periods of time at 300° C. in an
inert atmosphere as determined by ¹H NMR.

| Time @ 300 C. | RDOA-HER/PET | RDOA-EG/PET | RDOA-NPG/PET |
|---|---|---|---|
| (min) | (Example 51) | (Example 52) | (Example 53) |
| 0 | 22.8 | 13.1 | 18 |
| 4 | 9.4 | 4.6 | 13.9 |
| 32 | 2.6 | 1.6 | 10.5 |
| 128 | 1.4 | 1 | 8 |
| 256 | 1.1 | 1 | 3.4 |

### EXAMPLE 54

### Solid Stating of Transesterification Resistant Block Polyester

A Büchi GKR-50 flash distillation apparatus was used to heat samples in vacuo. A sample of the block polyester from example 17 was crystallized by heating to ca 70° C. for a period of 16 hours under 30 mmHg. The apparatus was then attached to a vacuum pump equipped with liquid nitrogen trap. After 0.5 hours the pressure stabilized to 0.35-0.5 mm Hg. and the temperature was raised to 200±20° C. and maintained at that temperature for 6.5 hours.

The product was characterized by GPC, which showed that the molecular weight had increased (from number average molecular weight ca. 16000 to 25000), and ¹H NMR showed that the sequence length was unchanged thus demonstrating the polymer had not undergone transesterification during solid stating.

Throughout this specification and the claims which follow, unless the context requires otherwise, the word “comprise”, and variations such as “comprises” and “comprising”, will be understood to imply the inclusion of a stated integer or step or group of integers or steps but not the exclusion of any other integer or step or group of integers or steps.

The reference to any prior art in this specification is not, and should not be taken as, an acknowledgment or any form of suggestion that that prior art forms part of the common general knowledge in Australia.

Those skilled in the art will appreciate that the invention described herein is susceptible to variations and modifications other than those specifically described. It is to be understood that the invention includes all such variations and modifications. The invention also includes all of the steps, features, compositions and (co)polymers referred to or indicated in this specification, individually or collectively, and any and all combinations of any two or more of said steps or features.

The claims defining the invention are as follows:

1. A polyester composition which is obtainable by combining a precursor polyester comprising at least one transesterification resistant segment with another polyester and/or monomer, wherein an alcohol or derivative thereof from which the precursor polyester is derived is responsible for the transesterification resistance of the segment.

2. A composition according to claim 1, comprising a block copolyester obtainable by reacting the precursor polyester and the another polyester and/or monomer.

3. A composition according to claim 1 or 2, wherein the alcohol is a diol or higher alcohol.

4. A composition according to claim 3, wherein the alcohol is selected from 2-methyl-1,3-propanediol, 2,4-pentanediol, 2,2-dimethyl-1,3-propanediol, 2,2-diethyl-1,3-propanediol, 2-methyl-2-ethyl-1,3-propanediol, 2-methyl-2-propyl-1,3-propanediol, 2-ethyl-2-isobutyl-1,3-propanediol, 2-ethyl-2-butyl-1,3-propanediol, 2,2-diphenyl-1,3-propanediol, 2,4-dimethyl-2-ethylhexane-1,3-diol, 2,2,4-trimethyl-1,3-pentanediol, 2,5-dimethyl-2,5-hexanediol, 2,4-dimethyl-2,4-pentanediol, 1,4-bis(2-hydroxypropyl)benzene, 1,3-bis(2-hydroxypropyl)benzene, 1,4-bis(1-hydroxy-2-methylpropyl)benzene, 1,3-bis(2,2-dimethyl-1-hydroxy-ethyl)benzene, 2,2,4,4-tetramethyl-1,5-pentanediol, 2,2,5,5-tetramethyl-1,6-hexanediol, 2,2,4-trimethyl-1,4-pentanediol, 2,2,5-trimethyl-1,5-hexanediol, 2-ethyl-1,3-hexanediol, 2-methyl-1,2-propanediol, 2,3-butanediol, 2-methyl-2,3-butanediol and 2,3-dimethyl-2,3-butanediol.

5. A composition according to claim 3, wherein the alcohol is selected from 1,3,5,7-tetramethyl-2,6-naphthalenediol, 1,3,6,8-tetramethyl-2,7-naphthalenediol, 2,5- 2, 6-, or 2,7-bis(2-hydroxypropyl)naphthalene and 2,5-, 2,6-, and 2,7-bis(1-hydroxy-2-methylpropyl)naphthalene.

6. A composition according to claim 3, wherein the alcohol is selected from 2,3,5,6-tetramethyl-hydroquinone; 2,4,6-trimethyl-1,3-dihydroxybenzene and 2,5-di-tert-butyl-hydroquinone.

7. A composition according to claim 3, wherein the alcohol is selected from 3,3′,5,5′-tetramethyl-4,4′-biphenol and, 3,3′,5,5′-tetra-tert-butyl-4,4′-biphenol, and isomers thereof.

8. A composition according to claim 3, wherein the alcohol is selected from 4,4′-methylene-bis-(2,6-di-methylphenol), 4,4′-methylene-bis-(2,6-di-tert-butylphenol), 2,2′-methylene-bis(4-methyl-6-tert-butyl-phenol), 2,2′-methylene-bis(4-ethyl-6-tert-butyl-phenol), 2,2′-thio-bis-(4-methyl-6-tert-butyl phenol) and the sulfate derivative thereof, 1,1′-thiobis(2-naphthol) and the sulfate derivative thereof, 2,2′-ethylene-bis-(2,6-di-tert-butyl-phenol), 2,2′-methylene-bis[6-(1-methylcyclohexyl)p-cresol], 2,2-di(3-methyl-4-hydroxyphenyl)propane, 4,4′-thio-bis(6-tert-butyl-m-cresol) and the sulfate derivative thereof and 4,4′-butylidene-bis(6-tert-butyl-m-cresol), and isomers thereof.

9. A composition according to claim 3, wherein the alcohol is selected from 2,3,5,6-tetramethyl-1,4-cyclohexanediol, 2,2,4,4-tetramethyl-1,3-cyclobutanediol, bis(hydroxyethyl)resorcinol and isomers thereof, and neopentyl glycol.

10. A composition according to claim 3, wherein the alcohol is selected from 1,1,3-tris(5-tert-butyl-4-hydroxy-2-methyl-phenyl)butane, 4,4-bis(4-hydroxyphenyl)valeric acid, 2,4-dimethyl-2,4-dihydroxy-3-(2-hydroxy-propyl)pentane and 2,4,6-tri(3,5-di-tert-butyl-4-hydroxy-benzyl)mesitylene.

11. A composition according to claim 3, wherein the alcohol is an alcohol-acid.

12. A composition according to claim 11, wherein the alcohol is selected from 3,3-dimethyl-4-hydroxy-butanoic acid, 3-hydroxy-butanoic acid, 2,2-dimethyl-3-hydroxy-butanoic acid, 2-hydroxy-butyric acid and 3-hydroxy-3-methyl-glutamic acid.

13. A composition according to any one of the preceding claims, wherein the polyester reacted with the precursor polyester is selected from polyalkylene terephthalates, poly(cyclohexylenedimethanol terephthalate), polyalkylene isophthalates, polyalkylene 2,6-naphthalene dicarboxylates, poly 4-hydroxybutyric acid, polycaprolactones, liquid crystalline polyesters, copolymers of these polyesters and blends of two or more thereof.

14. A composition according claim 13, wherein the polyester is selected from polyethylene terephthlalate, polypropylene terephthalate, polybutylene terephthalate, polyethylene naphthalate, polyethylene isophthalate, polyethylene-2,6-naphthalene dicarboxylate, poly(hydroxybenzoic acid), poly(2-hydroxy-6-naphthoic acid), poly(naphthalene terephthalate), copolymers of two or more thereof and blends of two or more thereof.

15. A composition according to claim 1, wherein the monomer is selected from bis(hydroxyethyl) resorcinol, 4-hydroxybenzoic acid, resorcinol dioxyacetic acid, isophthalic acid and 2,6-naphthalene dicarboxylic acid.

16. A composition according to claim 1, wherein the transesterification resistant segment is comprised predominantly (>90 mole %) of units derived from neopentyl glycol or bis(hydroxyethyl)resorcinol as diol and isophthalic acid 2,6-naphthalene dicarboxylic acid, resorcinol dioxyacetic acid or a combination thereof as diacid.

17. A composition according to any one of the preceding claims wherein the transesterification resistant segment comprises monomeric units that impart improved barrier properties, improved heat distortion temperature, improved flame retardancy, reduced flammability, improved biodegradeability, improved surface properties, improved tensile strength, improved modulus, improved rheology or improved oxygen scavenging properties to said composition.

18. A composition according to claim 17 wherein the monomeric units are selected from at least one of 2,6-naphthalene-dicarboxylic acids and alcohol derivatives, biphenyl acids and alcohol derivatives, diphenyl alkylene acids and alcohol derivatives and phenyl-containing acids and alcohol derivatives, isophthalic acid, resorcinol dioxyacetic acid and all isomers thereof, bis(hydroxyethyl)resorcinol and all isomers thereof, 4,4′-biphenol and all isomers thereof, 4,4-dicarboxy-biphenyl and all isomers thereof, 4,4′-thio-bis(phenol) and the sulphone derivative and all isomers thereof, 4,4′-thio-bis(benzoic acid) and the sulphone derivative and all isomers thereof, 1,1′-thiobis(2-naphthol) and the sulphone derivative and all isomers thereof, 1,1′-thiobis(2-naphthalenecarboxylic acid) and the sulphone derivative and all isomers thereof, 2,2,4,4-tetramethylcyclobutanedimethanol, 4 hydroxy benzoic acid, 2,2-dimethylmalonic acid and combinations thereof.

19. A composition according to claim 17 or 18 wherein the improved barrier properties are provided by monomeric units selected from at least one of bis(hydroxyethyl)resorcinol, 2,2,4,4-tetramethylcyclobutanediol, 4-hydroxybenzoic acid, resorcinol dioxyacetic acid, isophthalic acid, 2,6-naphthalene dicarboxylic acid and alcohol derivatives thereof, biphenyl acids and alcohol derivatives thereof, diphenylalkylene acids and alcohol derivatives thereof.

20. A composition according to claim 17 or 18 wherein the improved heat distortion temperature is provided from 2,2,4,4-tetramethylcyclobutanedimethanol.

21. An article formed from a polyester composition as claimed in any one of claims 1 to 20.

22. A process for preparing a polyester composition which comprises combining a precursor polyester comprising at least one transesterification resistant segment with another polyester and/or monomer, wherein an alcohol or derivative thereof from which the precursor polyester is derived is responsible for the transesterification resistance of the segment.

23. A process according to claim 22, wherein the precursor polyester and the polyester and/or monomer are combined in a melt processing operation.

24. A process according to claim 23 wherein the melt processing operation results in the formation of a block copolyester.

25. A process according to any one of claims 22 to 24 wherein the transesterification resistant segment comprises monomeric units that impart improved barrier properties, improved heat distortion temperature, improved flame retardancy, reduced flammability, improved biodegradeability, improved surface properties, improved tensile strength, improved modulus, improved rheology or improved oxygen scavenging properties to said polyester composition.

26. A process according to claim 25 wherein the monomeric units are selected from at least one of 2,6-naphthalene-dicarboxylic acids and alcohol derivatives, biphenyl acids and alcohol derivatives, diphenyl alkylene acids and alcohol derivatives and phenyl-containing acids and alcohol derivatives, isophthalic acid, resorcinol dioxyacetic acid and all isomers thereof, bis(hydroxyethyl)resorcinol and all isomers thereof, 4,4′-biphenol and all isomers thereof, 4,4-dicarboxy-biphenyl and all isomers thereof, 4,4′-thio-bis(phenol) and the sulphone derivative and all isomers thereof, 4,4′-thio-bis(benzoic acid) and the sulphone derivative and all isomers thereof, 1,1′-thiobis(2-naphthol) and the sulphone derivative and all isomers thereof, 1,1′-thiobis(2-naphthalenecarboxylic acid) and the sulphone derivative and all isomers thereof, 2,2,4,4-tetramethylcyclobutanedimethanol, 4 hydroxy benzoic acid, 2,2-dimethylmalonic acid and combinations thereof.

27. A process according to claims 25 or 26 wherein the improved barrier properties are provided by monomeric units selected from at least one of bis(hydroxyethyl)resorcinol, 2,2,4,4-tetramethylcyclobutanediol, 4-hydroxybenzoic acid, resorcinol dioxyacetic acid, isophthalic acid, 2,6-naphthalene dicarboxylic acid and alcohol derivatives thereof, biphenyl acids and alcohol derivatives thereof, diphenylalkylene acids and alcohol derivatives thereof.

28. A process according to claims 25 or 26 wherein the improved heat distortion temperature is provided from 2,2,4,4-tetramethylcyclobutanedimethanol.

29. Use of a precursor polyester as defined in claim 1, to prepare a block copolyester comprising at least one transesterification resistant segment.

30. Use as a barrier material of a polyester composition which is obtainable by combining a precursor polyester comprising at least one transesterification resistant segment with a monomer selected from bis(hydroxyethyl)resorcinol, 2,2,4,4-tetramethylcyclobutanediol, 4-hydroxybenzoic acid, resorcinol dioxyacetic acid, isophthalic acid, 2,2-dimethylmalonic acid, 2,6-naphthalene dicarboxylic acid and alcohol derivatives thereof, biphenyl acids and alcohol derivatives thereof, diphenylalkylene acids and alcohol derivatives thereof, and combinations thereof.

31. Use as a barrier material of a polyester composition which is obtainable by combining a precursor polyester comprising at least one transesterification segment with another polyester and/or monomer, wherein the transesterification resistant segment is derived from a monomer selected from bis(hydroxyethyl)resorcinol, 2,2,4,4-tetramethylcyclobutanediol, 4-hydroxybenzoic acid, resorcinol dioxyacetic acid, isophthalic acid, 2,2-dimethylmalonic acid, 2,6-naphthalene dicarboxylic acid and alcohol derivatives thereof, biphenyl acids and alcohol derivatives thereof, diphenylalkylene acids and alcohol derivatives thereof, and combinations thereof.

32. Use according to claim 31 wherein the polyester is derived from a monomer selected from bis(hydroxyethyl)resorcinol, 2,2,4,4-tetramethylcyclobutanediol, 4-hydroxybenzoic acid, resorcinol dioxyacetic acid, isophthalic acid, 2,2-dimethylmalonic acid, 2,6-naphthalene dicarboxylic acid and alcohol derivatives thereof, biphenyl acids and alcohol derivatives thereof, diphenylalkylene acids and alcohol derivatives thereof, and combinations thereof.

33. Use according to claim 31 wherein the monomer is selected from bis(hydroxyethyl)resorcinol, 2,2,4,4-tetramethylcyclobutanediol, 4-hydroxybenzoic acid, resorcinol dioxyacetic acid, isophthalic acid, 2,2-dimethylmalonic acid, 2,6-naphthalene dicarboxylic acid and alcohol derivatives thereof, biphenyl acids and alcohol derivatives thereof, diphenylalkylene acids and alcohol derivatives thereof, and combinations thereof.

34. A packaging material formed from a polyester composition as defined in any one of claims 30 to 33.

35. A process for modifying a polyester which comprises combining the polyester with a precursor polyester comprising at least one transesterification resistant segment, wherein the transesterification resistant segment is derived from monomeric units which impart improved barrier properties, improved heat distortion temperature, improved flame retardancy, reduced flammability, improved biodegradeability, improved surface properties, improved tensile strength, improved modulus, improved rheology or improved oxygen scavenging properties to said modified polyester.

36. A process according to claim 35 wherein modification results in formation of a block copolyester.

37. A process according to claim 35 or 36 wherein the monomeric units are selected from at least one of 2,6-naphthalene-dicarboxylic acids and alcohol derivatives, biphenyl acids and alcohol derivatives, diphenyl alkylene acids and alcohol derivatives and phenyl-containing acids and alcohol derivatives, isophthalic acid, resorcinol dioxyacetic acid and all isomers thereof, bis(hydroxyethyl)resorcinol and all isomers thereof, 4,4′-biphenol and all isomers thereof, 4,4-dicarboxy-biphenyl and all isomers thereof, 4,4′-thio-bis(phenol) and the sulphone derivative and all isomers thereof, 4,4′-thio-bis(benzoic acid) and the sulphone derivative and all isomers thereof, 1,1′-thiobis(2-naphthol) and the sulphone derivative and all isomers thereof, 1,1′-thiobis(2-naphthalenecarboxylic acid) and the sulphone derivative and all isomers thereof, 2,2,4,4-tetramethylcyclobutanedimethanol, 4 hydroxy benzoic acid, 2,2-dimethylmalonic acid and combinations thereof.

38. A process according to claim 35 or 36 wherein the improved barrier properties are provided by monomeric units selected from at least one of bis(hydroxyethyl)resorcinol, 2,2,4,4-tetramethylcyclobutanediol, 4-hydroxybenzoic acid, resorcinol dioxyacetic acid, isophthalic acid, 2,2-dimethylmalonic acid, 2,6-naphthalene dicarboxylic acid and alcohol derivatives thereof, biphenyl acids and alcohol derivatives thereof, diphenylalkylene acids and alcohol derivatives thereof.

39. A process according to claim 35 or 36 wherein the improved heat distortion temperature is provided from 2,2,4,4-tetramethylcyclobutanedimethanol.

40. A polyester composition which is obtainable by combining a precursor polyester comprising at least one transesterification resistant segment with another polyester and/or monomer, wherein the transesterification resistant segment of the precursor polyester is not derived from a sterically hindered di-acid or derivative thereof.
